(19) United States
(12) Patent Application Publication
(10) Pub. No.: US 2004/0169020 A1
(43) Pub. Date: Sep. 2, 2004

(54) Method and device for installation

(76) Inventor: Akira Yamauchi, Shiga (JP)

Correspondence Address: SMITH PATENT OFFICE, 1901 PENNSYLVANIA AVENUE N W, SUITE 200, WASHINGTON, DC, 20006

(21) Appl. No.: 10/481,445

(22) PCT Filed: Jun. 12, 2002
(86) PCT No.: PCT/JP02/05829

(30) Foreign Application Priority Data
Jun. 20, 2001 (JP) 2001-187164
Feb. 20, 2002 (JP) 2002-43378
Apr. 24, 2002 (JP) 2002-12244

(51) Int. Cl. B23K 10/00

(52) U.S. Cl. 219/121.46

(57) ABSTRACT

A method and a device for mounting: the method characterized by comprising the steps of forming an energy wave or energy particle flow area (9) in a clearance formed between objects to be bonded having metal connection parts (4) and (5) before bonding the objects to each other, cleaning the surfaces of the metal connection parts (4) and (5) of the objects substantially simultaneously by the flowing energy wave or the energy particles, and bonding to each other the metal connection parts (4) and (5) of both objects having the surfaces activated by cleaning, whereby, basically, a chamber becomes unnecessary, the use of a large amount of special gas also becomes unnecessary, the metal connection parts (4) and (5) can be activated by efficiently cleaning out the surfaces thereof, and a bonding at a room temperature or a low temperature becomes possible.

### TECHNICAL FIELD OF THE INVENTION

The present invention relates to mounting method and device for bonding an object to be bonded such as a chip, which has a metal connection part such as a solder bump, to another object to be bonded such as a substrate, which has a metal connection part, and specifically, to mounting method and device for bonding the metal connection parts to each other efficiently by cleaning the surfaces of the metal connection parts and activating the surfaces.

### BACKGROUND ART OF THE INVENTION

A mounting method for bonding an object with a metal connection part such as a solder connection part to another object, for example, a chip mounting method for forming a solder bump on a chip, approaching the chip to a substrate at a face-down condition, bringing the solder bump into contact with a pad of the substrate, and thereafter heating and melting the bump of the chip to bond it to the pad of the substrate, is well known. In such a flip-chip process using a solder bump, there is a fear that the solder bump is primarily oxidized before bonding step by being touched with an atmosphere, etc., or, there is a fear that organic substances or foreign materials adhere to the surface of the solder bump. Thus, if an oxide film is formed on the surface of the metal connection part or organic substances or foreign materials adhere to the surface of the metal connection part, there is a fear that a target bonded state cannot be obtained. To prevent these, in a conventional mounting under an atmospheric pressure, bonding at a fairly high temperature has been required.

On the other hand, a bonding method at a room temperature or at a temperature near the room temperature by cleaning a surface of a metal connection part by an energy wave or energy particles and activating the surface has been known. For example, in Japanese Patent 2,791,429 discloses a room-temperature bonding method of silicon wafers for sputter etching the bonding surfaces of both silicon wafers by irradiating an inert gas ion beam or an inert gas high-speed atomic beam to the surfaces at a vacuum condition with a room temperature prior to the bonding. In this room-temperature bonding method, oxides or organic substances on the bonding surfaces of silicon wafers are removed by the above-described beam and the surfaces are formed by silicon atoms activated by the beam, and both surfaces are bonded to each other by a strong bonding force between the activated atoms. Therefore, in this method, heating for bonding is not necessary, and it is possible to bond the objects at a room temperature.

Further, in the conventional mounting, a method is also known wherein, since there is a fear that a surface of a metal connection part is secondarily oxidized in an oxidizing atmosphere at the time of heat bonding and immediately therebefore, the inside atmosphere of a chamber is replaced with an inert gas at an atmospheric pressure and at that condition the bonding is carried out to suppress the secondary oxidation.

In the above-described conventional general method, however, there is a problem that, for bonding the surfaces of metal connection parts to each other, diffusion at a high temperature and the like is required in order to treat an oxide film, organic substances, adhered materials, etc. Further, although it becomes possible to bond objects at a room temperature or at a low temperature by surface activation as shown in Japanese Patent 2,791,429 if the bonding is carried out at a vacuum condition, in this case, there is a problem that a vacuum chamber is necessary and a large-scale equipment is also required for achieving a high-vacuum condition. Furthermore, although a better bonding becomes possible even in an atmospheric pressure by replacement with inert gas as described above, in this case, there is a problem that a chamber for enclosing the inert gas is required and a large-scale equipment for supplying a large amount of inert gas to replace the inside of the chamber with the inert gas is required. Namely, in the conventional methods, in order to carry out bonding in an inert gas atmosphere or at a vacuum condition so as to prevent the formation of an oxide film due to primary oxidation, basically a large-scale chamber is required.

Further, even if there is a surface cleaning process for activating a surface as described above, if the surface cleaning process is provided as a process prior to a bonding process, because the surface of an object is exposed to an atmosphere when the object is conveyed from the surface cleaning process to the bonding process, it occurs at a high possibility that an oxide film is reformed on the surface of the object more or less. If an oxide film is reformed, as compared with a case where such an oxide film is not reformed, the time required for bonding becomes greatly longer, and by this increase of time, the efficiency of the bonding process decreases.

Furthermore, although another method may be considered wherein the surface cleaning process for surface activation and the bonding process are carried out in chambers different from each other, a cleaned object is transferred into a bonding chamber while the surface cleaning state for surface activation in a cleaning chamber is maintained, and the bonding is carried out in the bonding chamber the inside of which is replaced with an inert gas atmosphere or controlled at a vacuum condition, even if the inside of the bonding chamber is turned into an inert gas atmosphere condition or a vacuum condition, formation of a perfect inert gas atmosphere or a perfect vacuum condition is difficult in practice. Therefore, even in an atmosphere formed by such a method, a small amount of impurities, moisture or foreign materials may be contained, and the bonding state of the objects may be in fluenced. Moreover, in a case employing an inert gas atmosphere, there is a problem that a large amount of gas to be replaced becomes necessary.

### DISCLOSURE OF THE INVENTION

Accordingly, a purpose of the present invention is to provide method and device for mounting which can basically make a large-scale chamber unnecessary, can also make use of a large amount of special gas such as inert gas unnecessary, and can efficiently clean a surface of a metal connection part of an object conveyed in an atmosphere and activate the surface, thereby enabling a room temperature bonding or at a temperature which is not particularly elevated.

Further, another purpose of the present invention is to provide method and device for mounting in which cleaning and bonding are carried out in chambers different from each other, and even in a state where both chambers are connected, a surface of a metal connection part immediately before bonding is formed at a preferred condition and a desirable bonding state can be efficiently obtained.

To achieve the above-described purposes, a mounting method according to the present invention for bonding objects to be bonded each having a metal connection part comprises the steps of forming an energy wave or energy particle flowing area in a clearance formed between the objects facing each other before bonding the objects to each other; cleaning surfaces of the metal connection parts of both objects substantially simultaneously by flowing energy wave of energy particles; and bonding to each other the metal connection parts of both objects having the surfaces activated by cleaning.

In this mounting method, before the objects having been conveyed in an atmosphere are bonded to each other, the surfaces of the metal connection parts of both objects can be cleaned substantially simultaneously, and the metal connection parts of both objects having the surfaces activated by cleaning can be bonded to each other.

Namely, the surfaces of the metal connection parts of both objects conveyed in an atmosphere are cleaned simultaneously, and the surfaces of the metal connection parts of both objects are bonded to each other at a condition where both surfaces are activated. Since the bonding carried out immediately after oxide films and organic substances on the surfaces are removed by the energy wave or energy particles and reformation of the oxide films and organic substances can be maintained to be prevented, bonding at an atmospheric pressure, particularly, bonding substantially in air with an atmospheric pressure, becomes possible. Where, “bonding substantially in air with an atmospheric pressure” means that, because pressure reduction or replacement with an inert gas is also possible in a case using an already existing device with a chamber, etc., at least any one of such conditions capable of being employed may be added. However, even in a case of pressure reduction, a high-vacuum condition such as a condition which has been employed in a conventional method is not required, and also in a case of replacement with an inert gas, supply of a large amount of gas such as supply which has been employed in a conventional method is not required, for example, as described later, an amount of inert gas may be at about a degree which is exhibited by an inert gas flow accompanied with a plasma flow for generation of the plasma. Further, in a case where a chamber is newly provided, the chamber may be a small chamber which can partially seal a portion between both objects.

Further, in the above-described mounting method, a method can be employed wherein, after the metal connection parts of the objects are cleaned in a cleaning chamber by an energy wave or energy particles, the objects are transferred into a bonding chamber, the inside of the bonding chamber is controlled at an inert gas atmosphere or a vacuum condition, before the objects are bonded to each other, the surfaces of the metal connection parts of both objects are cleaned substantially simultaneously, and the metal connection parts of both objects having the surfaces activated by cleaning are bonded to each other.

Namely, the technical concept in the present invention that is the simultaneous cleaning of the surfaces of the metal connection parts of both objects immediately before bonding, can be developed to mounting method wherein cleaning and bonding of the metal connection parts of the objects are carried out chambers different from each other and both chambers are connected. In this case, even if a small amount of impurities, moisture or foreign materials are contained in the bonding chamber, the surfaces of the metal connection parts of both objects are cleaned substantially simultaneously immediately before bonding by the energy wave or the energy particles flown into a clearance formed between both objects facing each other, and after a desirable condition for bonding without impurities, moisture or foreign materials is created, the bonding is carried out. Namely, immediately before bonding, the portions to be bonded are locally cleaned efficiently. Therefore, even in this case, it is not necessary to replace the whole of the inside of the bonding chamber using a large amount of inert gas or control the inside at a high vacuum condition.

Further, in the above-described mounting method, a method can be employed wherein, after the metal connection parts of the objects are cleaned in a cleaning chamber by an energy wave or energy particles, the objects are conveyed in an atmosphere while being purged with non-oxidizing gas, before the conveyed objects are bonded to each other, the surfaces of the metal connection parts of both objects are cleaned substantially simultaneously, and the metal connection parts of both objects having the surfaces activated by cleaning are bonded to each other.

Namely, the technical concept in the present invention that is the simultaneous cleaning of the surfaces of the metal connection parts of both objects immediately before bonding, can also be applied to a case where cleaning of the surfaces of the metal connection parts of the objects is carried out in a cleaning chamber, the objects are conveyed to the bonding portion and the mounting is carried out. In this case, when the cleaned objects are conveyed in an atmosphere, the clean state after the cleaning can be maintained by conveying while purging with non-oxidizing gas, and at that state, the surfaces of the metal connection parts of both objects are cleaned substantially simultaneously immediately before bonding by the energy wave or the energy particles flown into a clearance formed between both objects facing each other, and after a desirable condition for bonding without impurities, moisture or foreign materials is created, the bonding is carried out. Namely, immediately before bonding, the portions to be bonded are locally cleaned efficiently. Therefore, also in this case, since the objects are bonded immediately after creating a condition where reformation of oxide films, etc. is prevented, bonding at an atmospheric pressure, especially, bonding substantially in air at an atmospheric pressure, becomes possible. As the non-oxidizing gas for purging, for example, non-oxidation gas, inert gas, reducing gas, etc. such as argon gas or nitrogen gas can be used.

As the used energy wave or energy particles used for the above-described simultaneous cleaning before bonding, any one of a plasma (including an atmospheric-pressure plasma), an ion beam, an atomic beam, a radical beam and a laser can be employed, but from the viewpoints of easy handling and good effect of surface cleaning, it is preferred to use a plasma (including an atmospheric-pressure plasma) or an ion beam.

In order to simultaneously clean the surfaces of the metal connection parts of both objects facing each other before bonding by the energy wave or the energy particles, it is preferred to flow the energy wave or the energy particles into the clearance formed between both objects facing each from a side of the clearance.

In a case where the energy wave or the energy particles are flown from the side, although the energy wave or the energy particles may be flown just from the side into the clearance formed between both objects, which are disposed in parallel to each other so as to face each other, in a direction parallel to the direction the clearance extends, in order that the energy wave or the energy particles are irradiated more appropriately to a surface to be cleaned, it is preferred that the flow direction is inclined relatively to the surface to be cleaned and a predetermined angle is given thereto.

To give this angle, two typical methods can be employed. Namely, employed are any one of a method for inclining at least one of the objects relatively to a flow direction of the energy wave or energy particles at the time of simultaneous cleaning, that is, a method for inclining the object side, and a method for setting a plurality of flow directions of the energy wave or energy particles and inclining the flow directions relatively to at least one of the objects.

Further, in the mounting method according to the present invention, a method may be employed wherein at least a portion between both objects is locally controlled at a vacuum condition relatively to an ambient atmosphere before both objects are bonded to each other, for example, this portion is sealed by a small chamber (a local chamber) and controlled at a vacuum condition (a reduced pressure condition), and the energy wave or energy particles are flown into the portion between both objects and the surfaces of the metal connection parts of both objects are cleaned substantially simultaneously.

In a case where a plasma is used as the energy wave or energy particles for simultaneous cleaning, either the plasma may be supplied by a nozzle or the plasma may be generated between flat plate electrodes disposed in parallel to each other. For example, a plasma supply nozzle can be disposed so as to be directed to the portion between both objects. Alternatively, a plasma can be generated between electrodes provided at positions of the sides of the portion between object holding means facing each other. Further, a plasma can be generated between electrodes attached to the object holding means facing each other. Still further, a plasma can be generated by both the electrodes provided at positions of the sides of the portion between object holding means facing each other and the electrodes attached to the object holding means facing each other. Furthermore, when a plasma is generated by such electrodes, the cleaning can be carried out while a grounded-side electrode is electrically switched. Although it is preferred to flow a plasma, a case where a plasma is merely generated vaguely relatively to the above-described portion to be cleaned is also included in the technical concept of flowing plasma according to the present invention.

Further, in a case where the cleaning is carried out at a vacuum condition in a local chamber, for example, it is possible to once replace an atmosphere at least between the objects with non-oxidizing gas after cleaning, and to bond both objects at an atmospheric pressure.

Furthermore, when both objects are bonded to each other, it is possible to heat at least one of the objects while electrostatically holding it.

The above-described switching technology of electrodes for plasma generation may be applied to a case except the case where the metal connection parts of both objects are cleaned simultaneously, and the present invention provides such a technology development. Namely, the present invention provides a mounting method for bonding objects to be bonded each having a metal connection part comprising the steps of providing plasma generation electrodes to respective holding means for holding both objects at a condition facing both objects to each other; cleaning the metal connection parts of both objects by generating plasma between the electrodes and switching the irradiation direction of generated plasma by switching the polarities of both electrodes; and bonding to each other the metal connection parts of both objects having surfaces activated by cleaning.

In this mounting method, it is preferred that the cleaning is carried out in an inert gas atmosphere such as argon gas atmosphere or at a vacuum condition.

A mounting device according to the present invention for bonding objects to be bonded each having a metal connection part comprises an energy wave or energy particle supply means for supplying an energy wave or energy particles to a clearance formed between the objects facing each other before bonding the objects to each other so as to be able to clean surfaces of the metal connection parts of both objects substantially simultaneously.

The mounting device according to the present invention may comprise a cleaning chamber in which the metal connection parts of the objects are cleaned by an energy wave or energy particles, a bonding chamber which is connected to the cleaning chamber and in which transferred objects are bonded to each other in an inert gas atmosphere or at a vacuum condition, and an energy wave or energy particle supply means for cleaning the surfaces of the metal connection parts of both objects substantially simultaneously before bonding.

Further, the mounting device according to the present invention may comprise a cleaning chamber in which the metal connection parts of the objects are cleaned by an energy wave or energy particles, a conveying means for conveying cleaned objects in an atmosphere while purging the objects with non-oxidizing gas, and an energy wave or energy particle supply means for cleaning the surfaces of the metal connection parts of both objects substantially simultaneously before conveyed objects are bonded.

Also in the mounting device according to the present invention, a structure may be employed wherein, in order to incline the flow direction relatively to the surface to be cleaned and give a predetermined angle, at least one of means for holding both objects comprises means capable of inclining at least one of both objects relatively to the flow direction of the energy wave or energy particles at the time of simultaneous cleaning. Alternatively, a structure may be employed wherein the energy wave or energy particle supply means comprises means capable of setting a plurality of flow directions of the energy wave or energy particles and capable of inclining a flow direction relatively to at least one of both objects.

Further, in the mounting device according to the present invention, a structure may be employed wherein a local chamber for controlling at least a portion between both objects partially at a vacuum condition relatively to an ambient atmosphere before both objects are bonded to each other is provided, and the energy wave or energy particle supply means is disposed in the local chamber.

In a case where this structure is employed, it is preferred that at least a part of the local chamber comprises a resilient seal material, and whereby, it becomes easy to control the attitude of at least one of the objects.

As the energy wave or energy particle supply means, a plasma generation device can be used, for example, an atmospheric pressure plasma generation device can be used. As such a plasma generation device, a device having a gas charging means at a plasma generation portion can be used. Further, as the plasma generation device, any one of a device including a plasma supply nozzle and a device including flat plate electrodes disposed in parallel to each other can be used.

For example, in a case where the above-described local chamber is provided, the energy wave or energy particle supply nozzle can be provided as one member of the flat plate electrode-type plasma generation device.

Further, the plasma generation device may be structured so that electrodes are disposed at positions of the sides of the portion between the object holding means facing each other. Further, a structure may be employed wherein electrodes for generating plasma are provided to the object holding means facing each other. Furthermore, a structure may be employed wherein electrodes for generating plasma are provided to both the positions of the sides of the portion between the object holding means facing each other and the object holding means facing each other. Further, in order to generate the plasma uniformly in the area required to be generated, a structure having means for switching a grounded-side electrode electrically may be employed.

The energy wave or energy particle supply means for the simultaneous cleaning in an atmosphere at a vacuum condition before bonding may comprise an ion beam generation device.

Further, in the mounting device according to the present invention, means for once replacing an atmosphere at least between the objects with non-oxidizing gas after cleaning may be provided.

Further, in a case where a local chamber is provided, because use of a suction-type object holding means, particularly, use of a suction-type heat tool, becomes difficult when the inside of the local chamber is controlled at a vacuum condition, it is necessary to use another type holding means. For example, as the means for holding at least one of the objects at the time of bonding, a holding means having an interior wire pattern in a substrate and capable of holding the object electrostatically by applying an electricity even in an atmosphere at a vacuum condition, can be employed. In this case, as the means for holding at least one of the objects at the time of bonding, a holding tool having an interior wire pattern in a ceramic substrate and capable of holding an object electrostatically by applying an electricity even in an atmosphere at a vacuum condition can be used.

Such a holding tool may be structured so that the tool has two interior wire pattern systems, and the two systems are operated separately for generating an electrostatic force and for heating. Further, the holding means for holding the object electrostatically may be structured so as to operate also as an electrode for generating plasma.

In the mounting method and device according to the present invention, the bonding of the objects to each other may be carried out by a ultrasonic bonding means.

Further, the present invention also provides a mounting device for bonding objects to be bonded each having a metal connection part comprising plasma generation electrodes provided to respective holding means for holding both objects at a condition facing both objects to each other for cleaning metal connection parts of said objects; and a polarity switching means for switching the irradiation direction of generated plasma by switching the polarities of both electrodes.

In this mounting device, it is preferred that means for controlling at least a portion between both electrodes at an inert gas atmosphere or at a vacuum condition at the time of cleaning by plasma is provided.

In such mounting method and device according to the present invention, since the surfaces of the metal connection parts of both objects are cleaned simultaneously by the flowing energy wave or energy particles, the cleaning can be carried out remarkably efficiently in a short period of time. This cleaning can be carried out relatively to the objects conveyed in an atmosphere, the cleaning is carried out substantially immediately before bonding, and by the cleaning, oxides, organic substances, etc. can be adequately removed from the surfaces of both metal connection parts and the surfaces are both activated, and at such a state, at a condition where reformation of oxide films, etc. can be prevented, both surfaces are pressed to each other and bonded efficiently. Because the energy wave or energy particles may be flown into a small area between both objects, basically a chamber is unnecessary, and even if a chamber is not provided, the surfaces of both metal connection parts can be cleaned effectively by the flowing energy wave or energy particles. Moreover, because the surfaces of the metal connection parts adequately activated are bonded to each other, it becomes possible to bond them at a room temperature or at a low temperature. Further, even if heat bonding or ultrasonic bonding is carried out, because the surfaces adequately cleaned and activated are bonded to each other, it becomes possible to perform a desirable bonding more easily, and because impurities have been removed from the surfaces, the reliability of the bonding may be increased.

Further, even in a case where the simultaneous cleaning of the metal connection parts of both objects immediately before bonding according to the present invention is applied to a mounting method wherein cleaning of the metal connection parts of the objects and bonding thereof are carried out in chambers different from each other and both chambers are connected for mounting, by flowing the energy wave or energy particles into a narrow clearance formed between both objects facing each other immediately before bonding, both metal connection parts can be simultaneously cleaned efficiently and effectively, and the bonding can be started at a desirable condition where impurities, etc. have been removed from the surfaces. Therefore, a high-reliability bonding can be achieved without requiring use of a large amount of inert gas, etc.

Further, even in a case where the simultaneous cleaning of the metal connection parts of both objects immediately before bonding according to the present invention is applied to a mounting method wherein cleaning of the metal connection parts of the objects is carried out in a cleaning chamber, the objects are conveyed in an atmosphere while being purged with a non-oxidizing gas and the conveyed objects are served to bonding, by flowing the energy wave or energy particles into a narrow clearance formed between both objects facing each other immediately before bonding, both metal connection parts can be simultaneously cleaned efficiently and effectively, and the bonding can be started at a desirable condition where impurities, etc. have been removed from the surfaces. Therefore, a high-reliability bonding can be achieved without requiring use of a large amount of inert gas, etc.

Further, in the mounting method and device according to the present invention wherein electrodes for plasma generation are switched and the irradiation direction of plasma is switched, because the surfaces to be bonded of both objects can be both cleaned surely, the effect due to plasma cleaning can be exhibited surely and a high-reliability bonding can be achieved.

Thus, in the mounting method and device according to the present invention, since the surfaces to be bonded of both metal connection parts are simultaneously cleaned and activated by the energy wave or energy particles flowing locally into a clearance formed between both objects, basically while a chamber becomes unnecessary and use of a large amount of a special gas such as an inert gas also becomes unnecessary, an efficient bonding becomes possible. Further, by the surface activation of the metal connection parts, room-temperature bonding, or bonding at a temperature which is not particularly elevated, can be possible, and therefore, the mounting device and the mounting process can be greatly facilitated.

The mounting method and device according to the present invention can be carried out as simultaneous cleaning method and device immediately before bonding, even for a device having a cleaning chamber and a bonding chamber connected to each other or even for a case where objects are bonded after the objects cleaned in a cleaning chamber are conveyed while being purged with a non-oxidizing gas, and a high-reliability bonding can be achieved.

Further, when a local chamber structure is employed for simultaneous cleaning immediately before bonding, a bonding state with a higher reliability can be achieved. Further, in a case where the inside of the local chamber is controlled at a vacuum condition, by employing an electrostatic chuck heater, a desirable holding of the objects and heating thereof can be both carried out with no problem. Further, after cleaning, if heating is employed together at the time of bonding, the bonding reliability may be further increased, and if heating plus ultrasonic are employed, the bonding reliability may be increased more greatly.

The mounting method and device according to the present invention can be applied also to ultrasonic or heat bonding, and can contribute to facilitate the bonding and to increase the reliability of the bonding due to removal of impurities.

Furthermore, the present invention provides a switching technology of electrodes in plasma cleaning, and by this, the technology according to the present invention may be developed more broadly not only for a case of simultaneous cleaning but also another case.

### BRIEF EXPLANATION OF THE DRAWINGS

FIG. 1 is a schematic view of a mounting device according to a first embodiment of the present invention.

FIG. 2 is a partial perspective view showing a case where many metal connection parts are disposed in the device depicted in FIG. 1.

FIG. 3 is a schematic view of a mounting device according to a modification of the device depicted in FIG. 1, showing a case adding a gas charging means.

FIG. 4 is a schematic view of a mounting device according to a second embodiment of the present invention.

FIG. 5 is a partial schematic view of a mounting device according to a third embodiment of the present invention.

FIG. 6 is a partial schematic view of a mounting device according to a fourth embodiment of the present invention.

FIG. 7 is a partial schematic view of a mounting device according to a fifth embodiment of the present invention.

FIG. 8 is a partial schematic view of a mounting device according to a sixth embodiment of the present invention.

FIG. 9 is a partial schematic view of a mounting device according to a seventh embodiment of the present invention.

FIG. 10 is a partial schematic view of a mounting device according to an eighth embodiment of the present invention.

FIG. 11 is a partial schematic view of a mounting device according to a ninth embodiment of the present invention.

FIG. 12 is a partial schematic view of a mounting device according to a tenth embodiment of the present invention.

FIG. 13 is a schematic view of a mounting device according to an eleventh embodiment of the present invention.

FIG. 14 is a partial schematic view of a mounting device according to a twelfth embodiment of the present invention.

FIG. 15 is an enlarged schematic perspective view of a heat tool of the device depicted in FIG. 14 as viewed from its lower surface side.

FIG. 16 is a schematic view of a mounting device according to a thirteenth embodiment of the present invention.

FIG. 17 is a schematic view of a mounting device according to a fourteenth embodiment of the present invention.

FIG. 18 is a schematic view of a mounting device according to a fifteenth embodiment of the present invention.

### EXPLANATION OF LABELS

1, 21: mounting device

2: chip as one object to be bonded

3: substrate as the other object to be bonded

4: bump

5: pad

6: stage

7: tool

8: clearance

9, 29: flow area

10: atmospheric-pressure plasma generation device as means for supplying energy wave or energy particles

11: high voltage application means

12: grounded side

13: nozzle portion

14: gas charging means

15: suction tube

22: chamber

23: pressure reducing means

24: atmospheric-pressure plasma generation device

25: high voltage application means

26 electrode

27: grounded side

28: counter electrode

30: cleaning chamber

31: purging means

32: nozzle

33: flow direction of energy wave or energy particles

41, 42, 51, 61: nozzle

71: local chamber

72: vacuum pump

73a, 73b: parallel flat-plate electrode

74: plasma generation device

75: resilient seal material

81, 91: local chamber

82, 92: resilient seal material

101, 101a, 101b: object to be bonded

102: cleaning chamber

103: energy wave or energy particles in cleaning chamber

104: energy wave or energy particle generation means

105: bonding chamber

106: conveying means

107: shutter means

108: tool

109: stage

110: plasma supply nozzle

111: local chamber

112: vacuum pump

113: head

114: heat tool (electrostatic chuck heater)

115: chip

116: stage

117: substrate

118a, 118b: parallel flat-plate electrode

119: plasma generation device

120: plasma

121a, 121b: interior wire pattern

131, 132: object to be bonded

133, 134: holding means

135, 136: electrode

137, 141: plasma

138: local chamber

142, 150: power source for plasma generation

151: inert gas supply means

152: vacuum pump

### THE BEST MODE FOR CARRYING OUT THE INVENTION

Hereinafter, desirable embodiments of the present invention will be explained referring to figures.

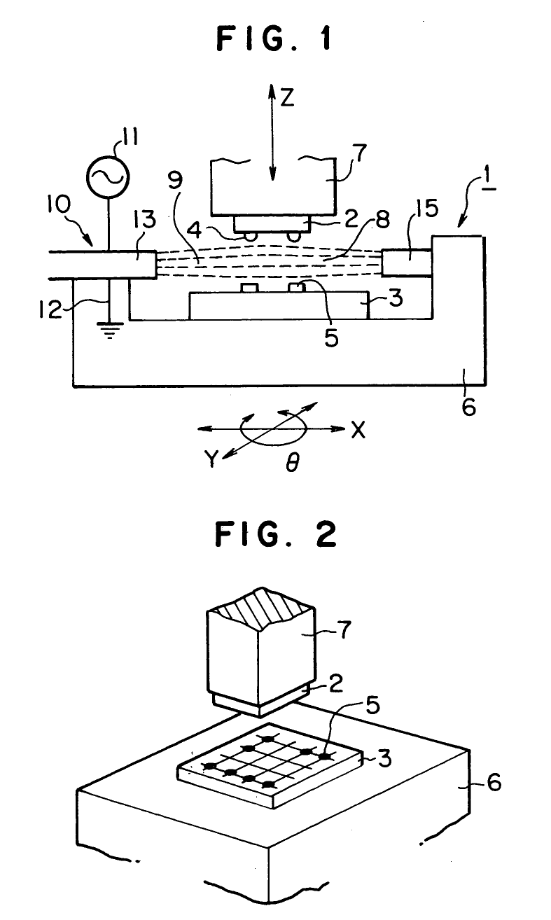

FIG. 1 shows a mounting device 1 according to a first embodiment of the present invention. FIG. 1 shows a case where a chip 2 is used as one of objects to be bonded to each other and a substrate 3 is used as the other. Many bumps 4 (in FIG. 1, two bumps 4 are shown) are provided on chip 2, and corresponding pads 5 (for example, electrodes) are provided on substrate 3. In this embodiment, stage 6 for holding substrate 3 and tool 7 for holding chip 2 are provided, stage 6 can be adjusted in position in X and Y directions (horizontal direction) or in X and Y directions and a rotational direction (θ direction), and tool 7 can be adjusted in position in Z direction (vertical direction) or in Z direction and a rotational direction. Both objects 2 and 3 are faced to each other at an appropriate clearance 8 before bonding by moving tool 7 down, and at this state, a flow area 9 of energy wave or energy particles is formed in the clearance 8 as described later. By flowing energy wave or energy particles, bumps 4 of chip 2 and pads 5 of substrate 3 as metal connection parts are cleaned simultaneously, and the surfaces of the bumps 4 and the pads 5 activated by cleaning are brought into contact with and bonded to each other by moving down tool 7 by an appropriate pressing means (not shown).

In the present invention, “chip 2” means all objects with forms being bonded to substrate 3 regardless the kind and size, such as an IC chip, a semiconductor chip, an optoelectronic element, a surface mounting part and a wafer. “Bump 4” means all parts with forms being bonded to pad 5 provided on substrate 3, such as a solder bump, a plated bump and a stud bump. Further, “substrate 3” means all objects with forms being bonded to chip 2 regardless the kind and size, such as a resin substrate, a glass substrate, a film substrate, a chip and a wafer. “Pad 5” means all parts with forms being bonded to bump 4 provided on chip 2, such as an electrode accompanying an electric wire and a dummy electrode which is not connected to an electric wire.

Although the above-described stage 6 and tool 7 are generally attached free to move in parallel and/or to rotate, as needed, they may be attached free to vertically move in combination with these parallel and/or rotational movement. Further, with respect to alignment between chip 2 and substrate 3, a device structure may be employed wherein tool 7 is moved down after alignment between chip 2 and substrate 3.

Although two bumps 4 of chip 2 and two pads 5 of substrate 3 are shown in FIG. 1, in most actual cases they are provided by more number, and for example, they exhibit a formation as shown in FIG. 2. Namely, many bumps 4 of chip 2 and many pads 5 of substrate 3 corresponding thereto are bonded simultaneously.

In FIG. 1, relatively to clearance 8 formed between chip 2 and substrate 3 facing each other before bonding, an atmospheric-pressure plasma generation device 10 is disposed at a side position of the clearance 8 as an energy wave or energy particle supply means (an energy wave or energy particle supply nozzle). This atmospheric-pressure plasma generation device 10 may be provided at a condition capable of being proceeded and retreated so as to be disposed at a predetermined position as requirements. Atmospheric-pressure plasma generation device 10 generates an atmospheric-pressure plasma, for example, between a high-voltage application means 11 and a grounded side 12, flows it into the above-described clearance 8 via a nozzle portion 13, and forms a predetermined plasma flow area 9.

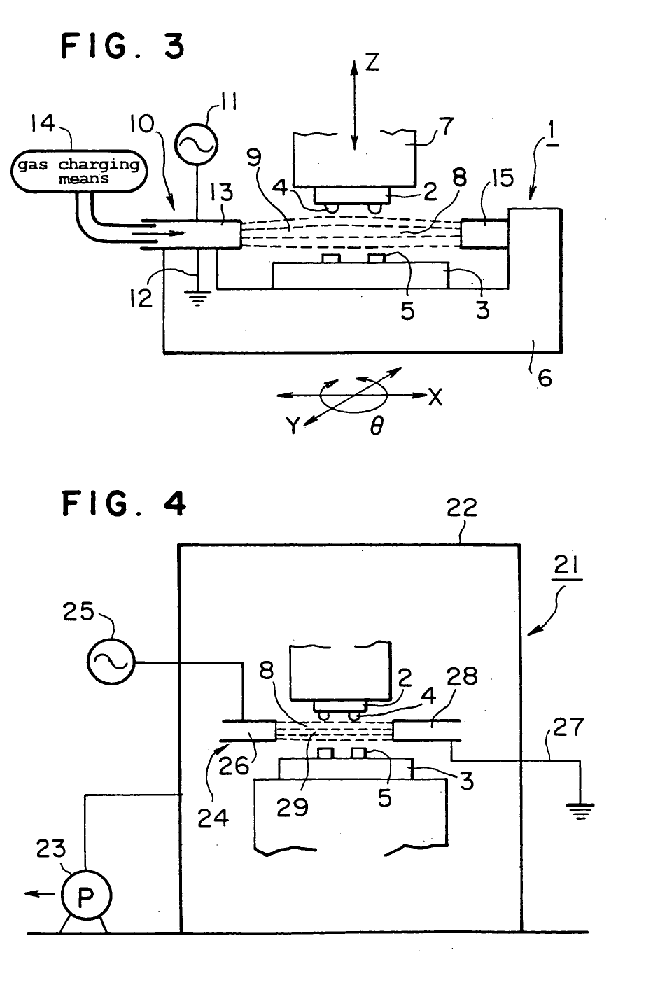

To this atmospheric-pressure plasma generation device 10, a gas charging means 14 may be attached, as shown in FIG. 3. Gas charging means 14 supplies gas to the plasma generation portion, facilitates the generation of plasma as well as flows the generated plasma into the above-described clearance 8 together with the gas flow. As the gas, for example, Ar, N₂ or He gas can be used, and further, a gas prepared by mixing such an inert gas with H₂, O₂, CF₄ gas or air can also be used.

The numeral 15 in FIGS. 1 and 3 indicates a suction tube provided for efficiently forming a desirable plasma flow area 9. In a case where a desirable plasma flow area 9 is formed unless suction tube 15 is provided, it may be omitted. Further, although high-voltage application means 11 is shown as an alternating current type, a direct current type may be employed.

The mounting method according to the present invention is carried out as follows using the mounting device 1 thus constructed.

As shown in FIG. 1, before both objects 2 and 3 conveyed in an atmosphere are bonded to each other, a plasma is supplied into clearance 8 formed between both objects 2 and 3 from atmospheric-pressure plasma generation device 10, and plasma flow area 9 is formed. By the flowing plasma, bumps 4 of chip 2 and pads 5 of substrate 3 facing each other are cleaned simultaneously, and the surfaces of the bumps 4 and the pads 5 are both activated by cleaning. Since bumps 4 and pads 5 having the activated surfaces are served to bonding as they are (namely, simultaneously with cleaning or immediately after cleaning), for example, even in air at an atmospheric pressure, it becomes possible to bond them at a room temperature or at a low temperature. Therefore, a large-scale chamber, which has been used in a conventional device, becomes unnecessary. At this state, by bringing bumps 4 into contact with pads 5 at an appropriate pressure by moving tool 7 down, the surfaces of bumps 4 and pads 5 are bonded, and a desirable bonding between chip 2 and substrate 3 is carried out efficiently.

At that time, a heater may be incorporated into tool 7 and heating together with the above-described pressing may be carried out. A further easier bonding becomes possible by heating. However, because the surfaces of bumps 4 and pads 5 are activated by cleaning and they are in a condition being bonded very easily, a high-temperature heating such as a case of a conventional bonding by merely heating is not necessary. For example, in a case of gold/gold bonding, although a high-temperature heating of about 400° C. has been required in a conventional heat-bonding method, in the method according to the present invention, bonding becomes possible by heating at a temperature of about 150° C. to 200° C. Further, also for ultrasonic bonding, the bonding may be facilitated by activating the surfaces of the metal connection parts by cleaning.

Further, as shown in FIG. 3, by adding a gas charging means 14, because plasma can be generated more easily and a small amount of gas flows into flow area 9 accompanying with the plasma flow, the bonding portion between bumps 4 and pads 5 is locally placed in a gas atmosphere, and the bonding can be carried out at a condition where the surface oxidization is prevented more surely. Therefore, a desirable bonding state can be obtained more surely.

Although unnecessity of a chamber can be achieved in the above-described embodiment, for example, in a case where the present invention is applied to a mounting device to which a chamber has been provided, it is possible to carry out bonding at a vacuum condition (reduced pressure condition) utilizing the existence of the chamber.

For example, as a second embodiment is shown in FIG. 4, a mounting device 21 is structure wherein a chamber 22 is provided, a pressure reducing means 23 (for example, a vacuum pump) is connected to the chamber 22, and an atmospheric-pressure plasma generation device 24 is provided as an energy wave or energy particle supply nozzle. In the embodiment shown in FIG. 4, atmospheric-pressure plasma generation device 24 is constructed as a structure wherein an electrode 26 connected to a high-voltage application means 25 is disposed at a position of one side of clearance 8 between chip 2 and substrate 3, a counter electrode 28 connected to grounded side 27 is disposed at a position of the other side, and a flow area 29 of the atmospheric-pressure plasma is formed between both electrodes, but the structure is not limited thereto. Bumps 4 of chip 2 and pads of substrate 3 are simultaneously cleaned by the atmospheric-pressure plasma flowing in flow area 29, and after being activated, they are bonded.

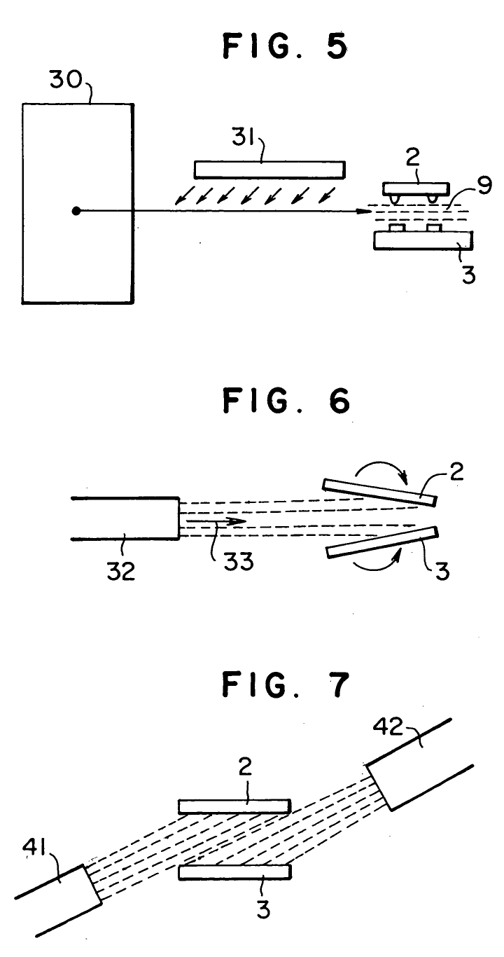

Further, in the present invention, for example as a third embodiment is shown in FIG. 5, in a case where objects (for example, chip 2 and substrate 3) are cleaned in a cleaning chamber 30, they are conveyed and they are simultaneously cleaned immediately before bonding by forming energy wave or energy particle flow area 9 similarly to a method shown in FIG. 1, a method maybe employed wherein the objects are purged by a non-oxidizing gas purging means 31 during the objects are conveyed in an atmosphere, and they are served to bonding while the clean state due to the cleaning in cleaning chamber 30 is maintained. Non-oxidizing gas purging means 31 may be formed as a fixed type or may be formed as a moving type which is moved together with the conveyed objects.

Further, in the above-described respective embodiments, although the energy wave or energy particles are flown from the side into the clearance formed between both objects disposed in parallel to each other so as to face each other in a direction parallel to the clearance extending direction, in order to irradiate the energy wave or energy particles to the surfaces of the objects to be cleaned more easily, it is preferred that the flow direction is inclined relatively to the surfaces to be cleaned and a predetermined angle is given.

For example, as a fourth embodiment is shown in FIG. 6, a method may be employed wherein by inclining tool 7 and/or stage 6 holding chip 2 and/or substrate 3, chip 3 and/or substrate 3 is inclined at a predetermined angle relative to flow direction 33 of energy wave or energy particles from a nozzle 33, thereby creating a condition where the flowing energy wave or energy particles are irradiated to the cleaning surfaces more easily. For this, the angle adjustment function provided to tool 7 and stage 6 themselves may be utilized.

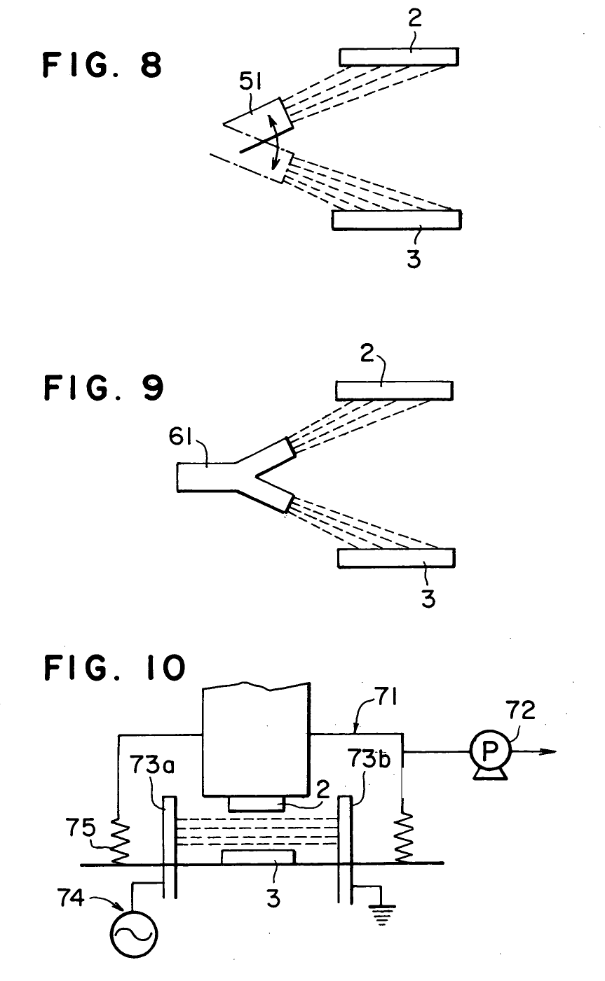

Further, as a fifth embodiment is shown in FIG. 7, a method may be employed, for example, wherein a plurality of nozzles (in the example shown in the figure, two nozzles 41 and 42) are provided, and the energy wave or energy particles are flown at a condition given with a predetermined angle relative to chip 2 or/and substrate 3. Further, as a sixth embodiment is shown in FIG. 8, a method also may be employed wherein, even if a single nozzle 51 is provided, the nozzle 51 is swung with a predetermined angle, energy wave or energy particles are flown alternately in both inclined angle directions, thereby forming a condition capable of carrying out substantially simultaneous cleaning. Furthermore, as a seventh embodiment is shown in FIG. 9, a method also may be employed wherein energy wave or energy particles are flown toward chip 2 and substrate 3 by a single divergent nozzle 61.

In the present invention, except the above-described atmospheric-pressure plasma type cleaning, it is possible to employ a method for forming a partial vacuum condition and cleaning. For example, as a schematic structure of a characterized portion of an eighth embodiment is shown in FIG. 10, a small-sized local chamber 71 is partially provided so that a portion between chip 2 and substrate 3 as both objects can be sealed, the inside of local chamber 71 is controlled at a vacuum condition (pressure reduced condition) by suction from local chamber 71 using a vacuum pump 72, etc., a plasma is flown between chip 2 and substrate 3 by, for example, a plasma generation device 74 having parallel flat plate electrodes 73a and 73b, and whereby simultaneous cleaning can be carried out. By forming at least a part of structural members of local chamber 71 with a resilient seal material 75, the control of the attitudes or the positions of chip 2 and substrate 3 can be easily carried out while a predetermined vacuum seal condition can be maintained.

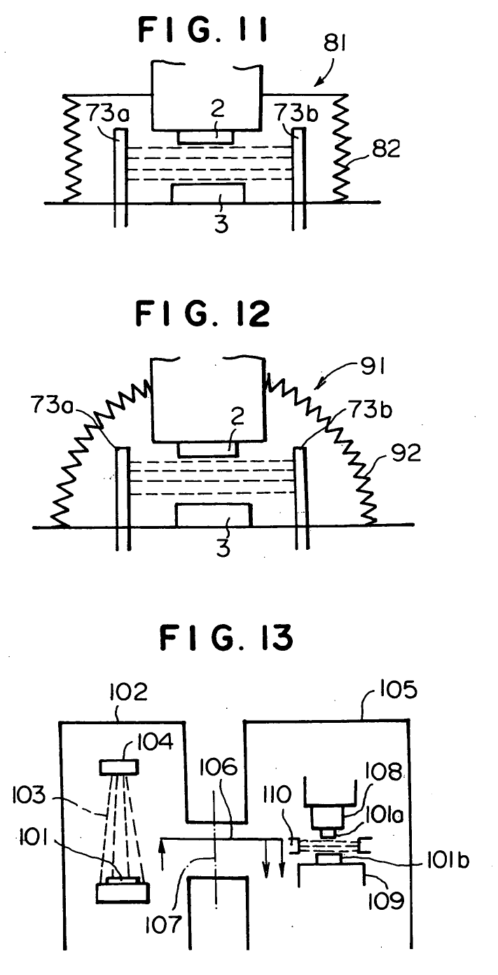

As a ninth embodiment is shown in FIG. 11, the above describe seal material may be structure as a resilient seal material 82 forming a side plate portion of local chamber 81, and for example, as a tenth embodiment is shown in FIG. 12, the whole of local chamber 91 may be formed by a resilient seal material 92. Any formation may be employed as long as the inside, particularly, a portion around the portions to be cleaned can be controlled at a predetermined vacuum condition, without being limited to the formations shown in FIGS. 10 to 12.

Thus, by controlling a portion between chip 2 and substrate 3 partially at a vacuum condition by sealing it with a small-sized local chamber and flowing a plasma into the portion, it becomes possible to generate a desirable plasma more easily as well as it becomes possible to increase the cleaning effect by flowing the plasma efficiently only to a necessary portion. This method may be applied to any bonding method such as a ultrasonic bonding except a heat bonding, thereby increasing the bonding reliability.

Further, the present invention can be developed to a mounting method wherein cleaning and bonding of metal connection parts of objects to be bonded are carried out in chambers different from each other and both chambers are connected to each other. For example, as an eleventh embodiment is shown in FIG. 13, the metal connection parts of object 101 to be bonded are cleaned in cleaning chamber 102 by energy wave or energy particle generation means 104 structured similarly to the above-described means, and the cleaned object 101 is transferred into bonding chamber 105. Cleaning chamber 102 and bonding chamber 105 are connected to each other, object 101 is transferred by a conveying means 106 such as a robot arm, and a shutter means 107 is provided between both chambers as needed. Objects 101a and 101b (for example, a chip and a substrate) transferred into bonding chamber 105 are held tool and stage 109, respectively, and after alignment, before bonding, a plasma flow area from plasma generation nozzle 110 similar to the above-described one is formed, and the metal connection parts of both objects are cleaned simultaneously and bonded to each other after the simultaneous cleaning.

In such a structure, it is possible to utilize an existing chamber and its connection structure as they are. Although the inside of bonding chamber 105 is frequently replaced with an inert gas or controlled at a vacuum condition, even in such a condition, because a small amount of impurities and foreign matters are difficult to be completely removed, by cleaning the metal connection parts of both objects simultaneously immediately before bonding and bonding them at that state, an extremely high-reliability bonding state can be obtained.

Further, in the present invention, in a case where a local chamber such as one shown in FIGS. 10 to 12 is formed and the inside of the local chamber is controlled at a vacuum condition, basically it becomes difficult to use a suction-type object holding means. In such a case, an electrostatic holding means, preferably, an electrostatic-type holding and heating means, may be employed.

For example, as a twelfth embodiment is shown in FIGS. 14 and 15, the inside of local chamber 111 is controlled at a vacuum condition by suction by vacuum pump 112, when chip 115 held on heat tool 114 (electrostatic chuck heater) at a lower portion of head 113 and substrate 117 held on stage 116 are bonded to each other, plasma 120 is flown between chip 115 and substrate 117 by plasma generation device 119 equipped with parallel flat plate electrodes 118a and 118b for example, whereby they are cleaned simultaneously, and after simultaneous cleaning, chip 115 and substrate 117 can be bonded to each other. In this embodiment, heat tool 114 has a function for holding chip 115 electrostatically and a function for heating the chip 115 held. Two-system interior wire patterns 121a and 121b are provided in heat tool 114 as shown in FIG. 15, one interior wire pattern 121a is used for electrostatic chuck due to an electrostatic force, and the other interior wire pattern 121b is used for heat bonding as a heater. Two-system interior wire patterns 121a and 121b are structured so as to be operated independently.

Although the electrostatic chuck structure is employed for the side of heat tool 114 holding chip 115, a similar structure may be employed also for the side of stage 116 holding substrate 117.

Further, in the present invention, as aforementioned, in a case where cleaning is carried out at a condition controlling the inside of a local chamber at a vacuum condition, for example, it is possible to once replace at least a portion between objects with a non-oxidizing gas (for example, an inert gas or nitrogen gas) after simultaneous cleaning and bond both objects at an atmospheric pressure. By this, the pressure in the chamber becomes an equilibrium condition relative to the outside, and a positional error ascribed to an offset load due to pressing force control and the head being pulled does not occur.

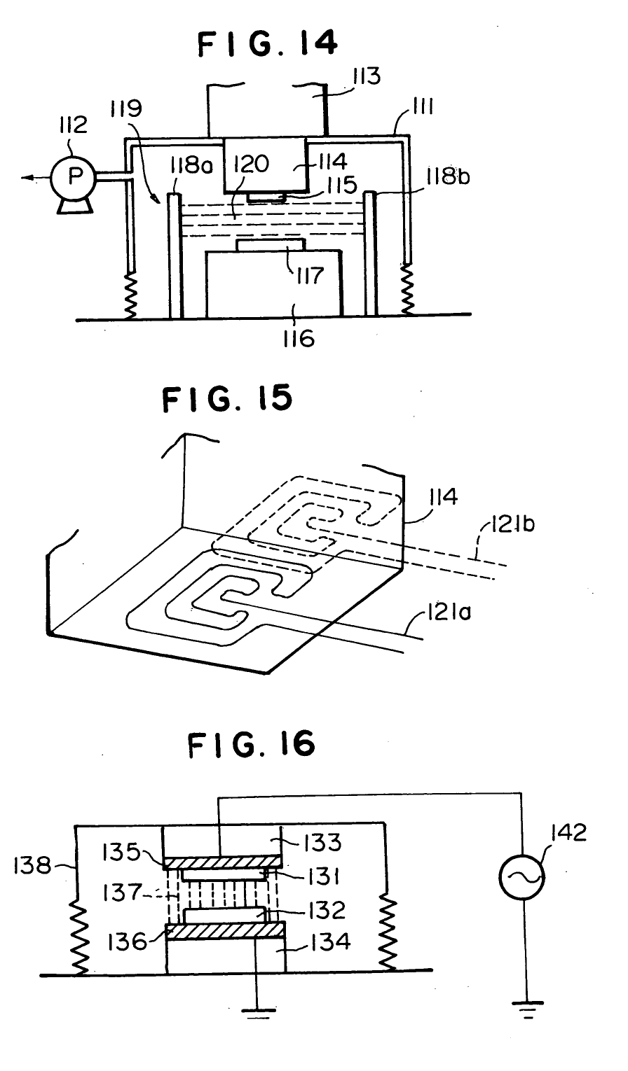

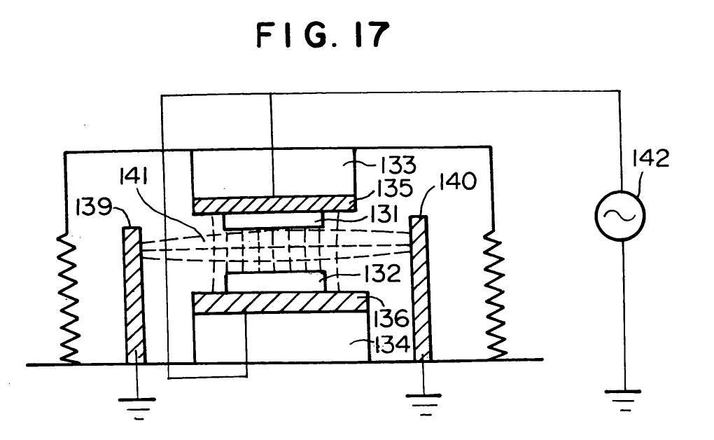

Further, in a case where a plasma is used as energy wave or energy particles for simultaneous cleaning, for example, embodiments such as an embodiment shown in FIG. 16 (a thirteenth embodiment) and an embodiment shown in FIG. 17 (a fourteenth embodiment) may be employed. In the embodiment shown in FIG. 16, electrodes 135 and 136 for plasma generation are provided to holding means 133 and 134 for holding upper and lower objects 131 and 132, and plasma 137 is generated between the objects 131 and 132 in local chamber 138 so that the plasma can flow vertically, that is, directly toward the surfaces of the objects 131 and 132. Further, in the embodiment shown in FIG. 17, the formation shown in FIG. 16 and the formation shown in FIG. 1 wherein parallel flat plate electrodes 139 and 140 (or peripheral electrodes) are provided at side positions are combined, and plasma 141 for simultaneous cleaning can be generated more densely between both objects 131 and 132. Although power source for plasma generation 141 shown in FIGS. 16 and 17 is an alternating current power source, it is also possible to use a direct current power source. Further, it is possible to carry out a more effective cleaning by providing means for switching a grounded-side electrode and appropriately switching the flow direction.

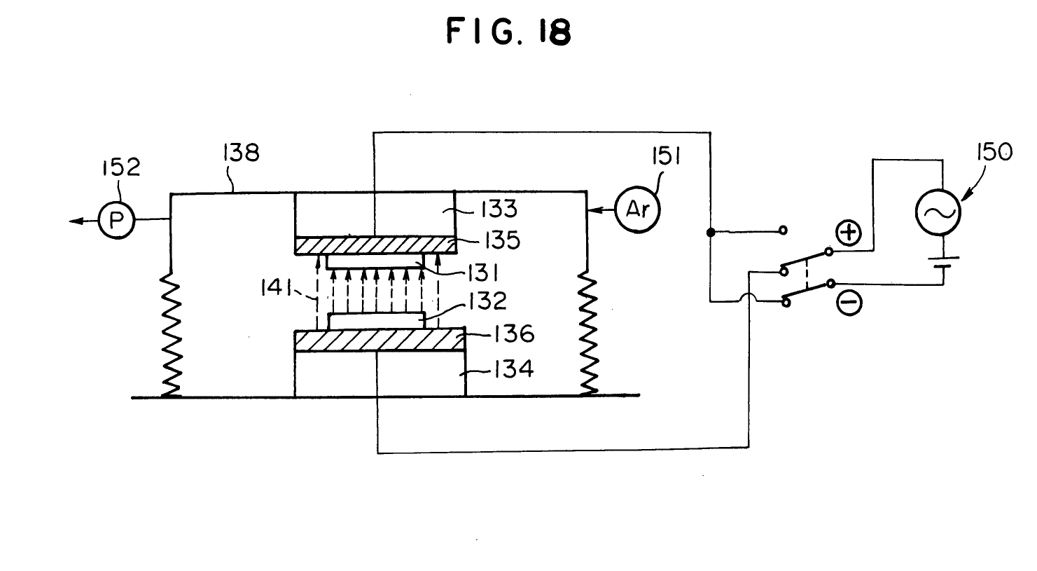

Further, the application of the above-described switching technology of electrodes for plasma generation is not limited to a case of simultaneous cleaning, but the technology can be developed to a case where the surfaces to be bonded are cleaned by plasma before bonding. For example, as a mounting device according to a fifteenth embodiment of the present invention is shown in FIG. 18, electrodes 135 and 136 for plasma generation are provided to holding means 133 and 134 for holding upper and lower objects 131 and 132, and plasma 137 is generated between the objects 131 and 132 in local chamber 138. Although a voltage for plasma generation is applied to both electrodes 135 and 136 from power source for plasma generation 150, by switching the polarities of both electrodes 135 and 136, the irradiation direction of the generated plasma 137 is switched, and whereby the surfaces to be bonded (the metal connection parts) of both objects 131 and 132 are cleaned alternately. By switching the irradiation direction of plasma, the surfaces to be bonded of both objects 131 and 132 are both cleaned. In this cleaning, in a case of Ar plasma, Ar⁺ plasma is pulled by the minus-side electrode as shown in FIG. 18, and the plasma collides with the surface of the object and the surface is cleaned. By switching this minus-side electrode electrically, both surfaces facing each other can be cleaned. Since both objects 131 and 132 are bonded to each other after this cleaning, the reliability of the bonding can be increased.

In the device shown in FIG. 18, further by replacing the inside atmosphere of local chamber 138 with an inert gas atmosphere by an inert gas supply means 151 for supplying an inert gas such as argon gas, or/and, by reducing the pressure in local chamber 138 and controlling it at a predetermined vacuum degree, plasma may be generated more easily and a more effective cleaning may be possible.

### INDUSTRIAL APPLICATIONS OF THE INVENTION

The mounting method and device according to the present invention can be applied to any mounting for bonding objects with metal connection parts to each other, and by applying the present invention, the surfaces of the metal connection parts can be effectively activated and the metal connection parts can be bonded to each other efficiently. Further, by the activation of the surfaces of the metal connection parts, a room-temperature bonding, or a bonding at a temperature that is not particularly elevated, becomes possible, thereby greatly simplifying mounting device and mounting process.

1. A mounting method for bonding objects to be bonded each having a metal connection part comprising the steps of:
forming an energy wave or energy particle flowing area in a clearance formed between said objects facing each other before bonding said objects to each other;
cleaning surfaces of said metal connection parts of both objects substantially simultaneously by flowing energy wave of energy particles; and
bonding to each other said metal connection parts of both objects having said surfaces activated by cleaning.

2. The mounting method according to claim 1, wherein, before said objects having been conveyed in an atmosphere are bonded to each other, said surfaces of said metal connection parts of both objects are cleaned substantially simultaneously, and said metal connection parts of both objects having said surfaces activated by cleaning are bonded to each other.

3. The mounting method according to claim 1, wherein, after said metal connection parts of said objects are cleaned in a cleaning chamber by an energy wave or energy particles, said objects are transferred into a bonding chamber, the inside of said bonding chamber is controlled at an inert gas atmosphere or a vacuum condition, before said objects are bonded to each other, said surfaces of said metal connection parts of both objects are cleaned substantially simultaneously, and said metal connection parts of both objects having said surfaces activated by cleaning are bonded to each other.

4. The mounting method according to claim 1, wherein, after said metal connection parts of said objects are cleaned in a cleaning chamber by an energy wave or energy particles, said objects are conveyed in an atmosphere while being purged with non-oxidizing gas, before said conveyed objects are bonded to each other, said surfaces of said metal connection parts of both objects are cleaned substantially simultaneously, and said metal connection parts of both objects having said surfaces activated by cleaning are bonded to each other.

5. The mounting method according to claim 1, wherein said energy wave or energy particles are flown into said clearance formed between said objects facing each other from a side of said clearance.

6. The mounting method according to claim 1, wherein at least one of said objects is inclined relatively to a flow direction of said energy wave or energy particles at the time of said simultaneous cleaning.

7. The mounting method according to claim 1, wherein a plurality of flow directions of said energy wave or energy particles at the time of said simultaneous cleaning are set, and the flow directions are inclined relatively to at least one of said objects.

8. The mounting method according to claim 1, wherein at least a portion between both objects is controlled at a vacuum condition relatively to an ambient atmosphere before both objects are bonded to each other, said energy wave or energy particles are flown into said portion between both objects and said surfaces of said metal connection parts of both objects are cleaned substantially simultaneously.

9. The mounting method according to claim 1, wherein a plasma is used as said energy wave or energy particles.

10. The mounting method according to claim 9, wherein said plasma is supplied by a nozzle.

11. The mounting method according to claim 9, wherein said plasma is generated between flat plate electrodes disposed in parallel to each other.

12. The mounting method according to claim 11, wherein said cleaning is carried out while a grounded-side electrode is electrically switched.

13. The mounting method according to claim 1, wherein an ion beam is used as said energy wave or energy particles.

14. The mounting Method according to claim 8, wherein an atmosphere at least between said objects is once replaced with non-oxidizing gas after cleaning, and both objects are bonded at an atmospheric pressure.

15. The mounting method according to claim 8, wherein at least one of said objects is heated while electrostatically held when both objects are bonded to each other.

16. The mounting method according to claim 1, wherein both objects are bonded to each other by a ultrasonic bonding means.

17. A mounting method for bonding objects to be bonded each having a metal connection part comprising the steps of:
providing plasma generation electrodes to respective holding means for holding both objects at a condition facing both objects to each other;
cleaning said metal connection parts of both objects by generating plasma between said electrodes and switching the irradiation direction of generated plasma by switching the polarities of both electrodes; and
bonding to each other said metal connection parts of both objects having surfaces activated by cleaning.

18. The mounting method according to claim 17, wherein said cleaning is carried out in an inert gas atmosphere or at a vacuum condition.

19. Amounting device for bonding objects to be bonded each having a metal connection part comprising an energy wave or energy particle supply means for supplying an energy wave or energy particles to a clearance formed between said objects facing each other before bonding said objects to each other so as to be able to clean surfaces of said metal connection parts of both objects substantially simultaneously.

20. The mounting device according to claim 19, wherein said mounting device comprises a cleaning chamber in which said metal connection parts of said objects are cleaned by an energy wave or energy particles, a bonding chamber which is connected to said cleaning chamber and in which transferred objects are bonded to each other in an inert gas atmosphere or at a vacuum condition, and an energy wave or energy particle supply means for cleaning said surfaces of said metal connection parts of both objects substantially simultaneously before bonding.

21. The mounting device according to claim 19, wherein said mounting device comprises a cleaning chamber in which said metal connection parts of said objects are cleaned by an energy wave or energy particles, a conveying means for conveying cleaned objects in an atmosphere while purging the objects with non-oxidizing gas, and an energy wave or energy particle supply means for cleaning said surfaces of said metal connection parts of both objects substantially simultaneously before conveyed objects are bonded.

22. The mounting device according to claim 19, wherein at least one of means for holding both objects comprises means capable of inclining at least one of both objects relatively to a flow direction of said energy wave or energy particles at the time of said simultaneous cleaning.

23. The mounting device according to claim 19, wherein said energy wave or energy particle supply means comprises means capable of setting a plurality of flow directions of said energy wave or energy particles and capable of inclining a flow direction relatively to at least one of both objects.

24. The mounting device according to claim 19, wherein a local chamber for controlling at least a portion between both objects partially at a vacuum condition relatively to an ambient atmosphere before both objects are bonded to each other is provided, and said energy wave or energy particle supply means is disposed in said local chamber.

25. The mounting device according to claim 24, wherein at least a part of said local chamber comprises a resilient seal material.

26. The mounting device according to claim 19, wherein said energy wave or energy particle supply means for said simultaneous cleaning before bonding comprises a plasma generation device.

27. The mounting device according to claim 26, wherein said plasma generation device includes a plasma supply nozzle.

28. The mounting device according to claim 26, wherein said plasma generation device includes flat plate electrodes disposed in parallel to each other.

29. The mounting device according to claim 28, wherein means for electrically switching a grounded-side electrode is provided.

30. The mounting device according to claim 19, wherein said energy wave or energy particle supply means for said simultaneous cleaning before bonding comprises an ion beam generation device.

31. The mounting device according to claim 24, wherein means for once replacing an atmosphere at least between said objects with non-oxidizing gas after cleaning is provided.

32. The mounting device according to claim 24, wherein a holding means for holding at least one of said objects at the time of bonding is provided, and said holding means has an interior wire pattern in a substrate and holds said object electrostatically by applying an electricity even in an atmosphere at a vacuum condition.

33. The mounting device according to claim 32, wherein a holding tool having an interior wire pattern in a ceramic substrate and capable of holding an object electrostatically by applying an electricity even in an atmosphere at a vacuum condition is provided as said holding means for holding at least one of said objects at the time of bonding.

34. The mounting device according to claim 33, wherein said holding tool has two interior wire pattern systems, and said two systems are operated separately for generating an electrostatic force and for heating.

35. The mounting device according to claim 32, wherein said holding means for holding said object electrostatically operates also as an electrode for generating plasma.

36. The mounting device according to claim 19, wherein a ultrasonic bonding means is provided.

37. Amounting device for bonding objects to be bonded each having a metal connection part comprising:
plasma generation electrodes provided to respective holding means for holding both objects at a condition facing both objects to each other for cleaning metal connection parts of said objects; and
a polarity switching means for switching the irradiation direction of generated plasma by switching the polarities of both electrodes.

38. The mounting device according to claim 37, wherein means for controlling at least a portion between both electrodes at an inert gas atmosphere or at a vacuum condition at the time of cleaning by plasma is provided.
